(19) United States
(12) Patent Application Publication
(10) Pub. No.: US 2026/0126824 A1
(43) Pub. Date: May 7, 2026

(54) KNOB ASSEMBLY AND FOLLOW FOCUS REMOTE CONTROLLER

(71) Applicant: TILTA INC., Burbank, CA (US)

(72) Inventors: Long MA, Shenzhen (CN); Wenping ZENG, Shenzhen (CN); Kefeng ZHOU, Shenzhen (CN)

(21) Appl. No.: 19/379,555

(22) Filed: Nov. 4, 2025

(30) Foreign Application Priority Data
Nov. 7, 2024 (CN) 202422716965.2

(51) Int. Cl. G05G 1/10; G03B 3/12

(52) U.S. Cl. CPC G05G 1/10; G03B 3/12

(57) ABSTRACT

A knob assembly and a follow focus remote controller are disclosed. The knob assembly includes a base, a rotating assembly, and a damping adjustment assembly. The rotating assembly is rotatably mounted on the base. The damping adjustment assembly includes a damping member and an actuator. The damping member is positioned between the base and the actuator. The actuator can drive the damping member to move, thereby altering the insertion depth of an insertion segment into a damping groove for housing damping grease. The damping grease creates a sticky sensation between the damping member and the base, enabling the user to adjust the damping feel to their preference and providing excellent damping feedback.

### CROSS-REFERENCE TO RELATED APPLICATIONS

The present application for patent claims priority to and the benefit of pending Chinese Application No. 2024227169652, filed November 7, 2024, and hereby expressly incorporated by reference herein as if fully set forth below in its entirety and for all applicable purposes.

### TECHNICAL FIELD

The present disclosure pertains to the field of lens parameter adjustment devices, specifically to a knob assembly and a follow focus remote controller.

### INTRODUCTION

When employing a camera for shooting, different compositions often necessitate adjustments to various lens parameters, such as zoom, focus, aperture, etc. Hence, it becomes imperative to rotate the lens for appropriate adjustment to capture the desired image. To simplify lens adjustment, follow focus remote controllers have been introduced in the market. By rotating the handwheel of the follow focus remote controller, the focal length of the corresponding shooting device can be altered. The resistance encountered during the rotation of the handwheel can be modified via a knob on the follow focus remote controller.

Although existing follow focus remote controllers enable lens parameter adjustment, they fall short in providing adequate operational feedback to the user, for instance, lacking an optimal damping feel when rotating the handwheel. This issue represents a technical problem that requires prompt resolution in the field.

### BRIEF SUMMARY

Aspects of the present disclosure provide a knob assembly and a follow focus remote controller that deliver superior damping operational feedback to users.

Some aspects of the present disclosure provide: a base; a rotating assembly, rotatably mounted on the base; and a damping adjustment assembly, including a damping member and an actuator. The damping member is situated between the base and the actuator. The actuator is movably connected to the rotating assembly and can rotate relative to the rotating assembly about the rotation axis of the base and the rotating assembly; this rotation is converted into linear movement along the rotation axis to drive the damping member to move accordingly. Either the base or the damping member has a damping groove for housing damping grease, while the other has an insertion segment that extends into the damping groove along the rotation axis; and the actuator can drive the damping member to move, changing the insertion depth of the insertion segment into the damping groove.

According to a second aspect, the present disclosure discloses a follow focus remote controller, including a remote controller main body and the aforementioned knob assembly, wherein the base of the knob assembly is fixable to the remote controller main body.

In the knob assembly according to the aforementioned embodiments and the follow focus remote controller incorporating it, when the actuator is rotated, it rotates relative to the combined entity of the damping member and the rotating assembly. The rotation of the actuator is converted into linear movement along the rotation axis of the base and the rotating assembly, causing the actuator to move relative to the rotating assembly along the rotation axis. This, in turn, drives the damping member to move along the rotation axis, adjusting the relative distance between the damping member and the base. The damping groove is filled with damping grease. When the insertion depth of the insertion segment into the damping groove varies, the amount of damping grease filling the gap between the insertion segment and the damping groove also changes, thereby altering the damping force when the damping member and the base rotate relative to each other. In the knob assembly disclosed in this disclosure, during the process of adjusting the insertion depth of the insertion segment into the damping groove by rotating the actuator, the rotating assembly as a whole does not rotate or move relative to the base. When the rotating assembly is driven to rotate relative to the base, both the actuator and the damping member rotate synchronously with the rotating assembly. Consequently, when the user drives the rotating assembly to rotate relative to the base for parameter adjustment, a sticky sensation is generated between the damping member and the base via the damping grease, providing the user with excellent damping feedback. The user can adjust the damping feel to their preference, enhancing the adaptability and practicality of the knob assembly and the follow focus remote controller.

### BRIEF DESCRIPTION OF THE DRAWINGS

FIG. 1 is a schematic diagram illustrating a follow focus remote controller according to some aspects of the disclosure.

FIG. 2 is a schematic illustrating a knob assembly according to some aspects of the disclosure.

FIG. 3 is a top view of the knob assembly of FIG. 2 according to some aspects of the disclosure.

FIG. 4 is a cross-sectional view taken along line A-A in FIG. 3 according to some aspects of the disclosure.

FIG. 5 is a cross-sectional view taken along line B-B in FIG. 3 according to some aspects of the disclosure.

FIG. 6 is an exploded view of the knob assembly of FIG. 2 according to some aspects of the disclosure.

FIG. 7 is another perspective view of FIG. 6 according to some aspects of the disclosure.

FIG. 8 is a schematic diagram illustrating a cooperation of an inner housing, a connecting shaft, a damping member, and a base in the knob assembly of FIG. 2 according to some aspects of the disclosure.

FIG. 9 is another perspective view of FIG. 8 according to some aspects of the disclosure.

### Reference Numerals:

1000 - follow focus remote controller; 100 - remote controller main body; 200 - knob assembly;

10 - base; 11 - damping groove; 12 - connection hole; 121 - positioning protrusion; 13 - bearing;

20 - rotating assembly; 21 - annular step; 211 - positioning recess; 22 - connecting shaft; 221 - limiting step; 23 - rotating housing; 231 - connecting part; 2311 - connecting disk; 2312 - rib; 232 - inner housing; 233 - outer housing; 2331 - first shell; 2332 - second shell; 2333 - third shell; 24 - first through hole;

30 - angle sensing assembly; 31 - rotating member; 32 - detector;

40 - damping adjustment assembly; 41 - damping member; 411 - insertion segment; 412 - insertion slot; 413 - grease groove; 42 - actuator; 421 - knob panel; 4211

- engagement slot; 4212 - limiting plate; 4213 - limiting boss; 4214 - knob portion; 422 - pressing panel; 4221 - engagement protrusion; 43 - elastic member; 44 - spring plunger.

### DETAILED DESCRIPTION

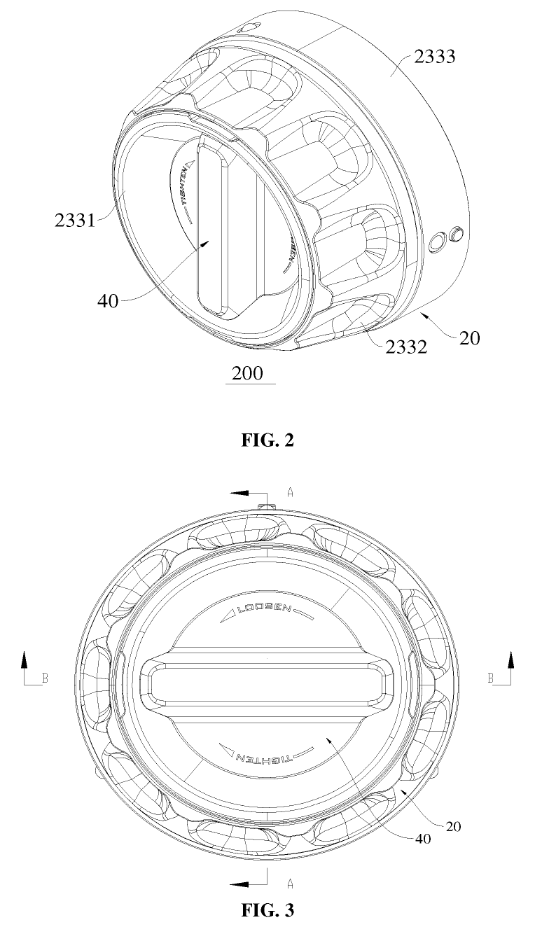

To balance both damping feel and adjustment precision during the adjustment process of a follow focus remote controller, the present disclosure provides a knob assembly 200. Referring to FIGS. 2-4, the knob assembly 200 includes a base 10, a rotating assembly 20, and a damping adjustment assembly 40. The base 10 serves as the mounting foundation for the other components. The rotating assembly 20 is rotatably mounted on the base 10. During the parameter adjustment process, the entire rotating assembly 20 is rotated relative to the base 10. The damping adjustment assembly 40 includes a damping member 41 and an actuator 42. The damping member 41 is positioned between the base 10 and the actuator 42. The actuator 42 is movably connected to the rotating assembly 20 and can rotate relative to the rotating assembly 20 about the rotation axis of the base 10 and the rotating assembly 20. This rotation is converted into linear movement along the rotation axis to drive the damping member 41 to move accordingly. Either the base 10 or the damping member 41 has a damping groove 11 for housing damping grease, while the other has an insertion segment 411 that extends into the damping groove 11 along the rotation axis. The actuator 42 can drive the damping member 41 to move, thereby changing the insertion depth of the insertion segment 411 into the damping groove 11.

Through analysis, it can be understood that, on one hand, the actuator 42 functions to adjust the position of the damping member 41 along the aforementioned rotation axis, thereby altering the insertion depth of the insertion segment 411 into the damping groove 11. The damping groove 11 is filled with damping grease. When the insertion depth of the insertion segment 411 into the damping groove 11 changes, the amount of damping grease filling the gap between the insertion segment 411 and the damping groove 11 also changes, thereby modifying the resistance when the damping member 41 and the base 10 rotate relative to each other. This achieves the damping adjustment effect through the damping grease in the gap between the insertion segment 411 and the damping groove 11. Since the damping member 41 and the rotating assembly 20 rotate synchronously, when the user operates the rotating assembly 20 to rotate relative to the base 10, the sticky damping sensation (e.g., viscous sensation) fed back to the user is pronounced, providing an excellent feel. The user can adjust the damping feel to their preference, enhancing the adaptability and practicality of the knob assembly 200 and the follow focus remote controller 1000.

In some aspects, when rotating the actuator 42, the rotating assembly 20 is manually held to prevent relative rotation between the rotating assembly 20 and the base 10. The rotation of the actuator 42 is converted into a displacement movement along the rotation axis of the base 10 and the rotating assembly 20. Through the transmission cooperation between the actuator 42 and the rotating assembly 20, both the actuator 42 and the damping member 41 move relative to the rotating assembly 20 along the rotation axis, thereby increasing or decreasing the damping effect. That is to say, during the process of adjusting the insertion depth of the insertion segment 411 into the damping groove 11 by rotating the actuator 42, the rotating assembly 20 as a whole does not rotate or move relative to the base 10. The operation of the rotating assembly 20 for parameter adjustment and the operation of the damping adjustment assembly 40 for damping effect adjustment are relatively independent. This independence enhances the overall practicality and operability of the knob assembly 200, reduces the difficulty of use, and facilitates user operation.

In summary, the use of the aforementioned knob assembly 200 involves two modes. When damping adjustment is needed, the rotating assembly 20 is fixed to prevent it from rotating relative to the base 10. At this time, the actuator 42 is rotated, causing both the actuator 42 and the damping member 41 to move towards or away from the base 10, thereby changing the insertion depth of the insertion segment 411 into the damping groove 11 to correspondingly increase or decrease the damping. When parameter adjustment is needed, the rotating assembly 20 is driven to rotate relative to the base 10. In this case, the rotating assembly 20 drives the damping member 41 and the actuator 42 to rotate, enabling parameter adjustment control.

In some aspects, the present disclosure does not specifically restrict the detailed transmission scheme by which the actuator 42 drives the damping member 41 to move along the rotation axis. The only requirement is that the position of the damping member 41 can change in accordance with the positional change of the actuator 42. For instance, in certain embodiments, under the drive of the actuator 42, the damping member 41 may solely move along the rotation axis towards or away from the base 10. That is, when the actuator 42 rotates relative to the rotating assembly 20, the damping member 41 remains stationary in terms of rotation relative to the rotating assembly 20 and only moves linearly along the rotation axis relative to both the base 10 and the rotating assembly 20. In other embodiments, the damping member 41 may rotate and move along the aforementioned rotation axis simultaneously with the actuator 42. In this scenario, the damping member 41 rotates relative to the base 10, enabling the user to experience the damping sensation during the process of adjusting the actuator 42, thus facilitating the user's adjustment of the damping feel to their desired level.

In some aspects, referring to FIGS. 3, 5, and 8, the damping adjustment assembly 40 can include an elastic member 43. The elastic member 43 is installed in the damping groove 11 and abuts against the insertion segment 411. Along the rotation axis, the elastic member 43 consistently presses the damping member 41 against the side of the actuator 42 facing the base 10, to adaptively adjust the position of the damping member 41 relative to the base 10 according to the position of the actuator 42, thereby altering the insertion length of the insertion segment 411 into the damping groove 11 and the magnitude of the rotational damping. In this scheme, the damping member 41 and the actuator 42 can be separated. The actuator 42 rotates and moves along the rotation axis, while the damping member 41 only moves linearly along the rotation axis under the action of the elastic member 43 and the actuator 42.

In some aspects, referring to FIGS. 3, 5 and 8, the elastic member 43 can be a spring. As the damping member 41 moves along the rotation axis, it compresses the spring to varying degrees, causing the spring to undergo different elastic deformations. Since the elastic deformation of the spring follows a linear pattern, the damping feel fed back to the user during the process of rotating the actuator 42 to change the insertion depth of the insertion segment 411 into the damping groove 11 will be relatively smooth, and the damping change during this process will also be uniform.

The present disclosure does not restrict the specific structure of the actuator 42 or the connection scheme between the actuator 42 and the rotating assembly 20, as long as the actuator 42 has the function of rotating while being capable of moving along the rotation axis of the base 10 and the rotating assembly 20. Furthermore, the central axis about which the actuator 42 rotates relative to the rotating assembly 20 may be coaxial with the rotation axis of the rotating assembly 20 and the base 10, or it may be offset, as long as the actuator 42 has a movement component along the rotation axis of the base 10 and the rotating assembly 20.

In some aspects, the actuator 42 can be a single integrated component. In this case, the actuator 42 is threadedly connected to the rotating assembly 20, enabling it to move towards or away from the base 10 along the thread direction while rotating.

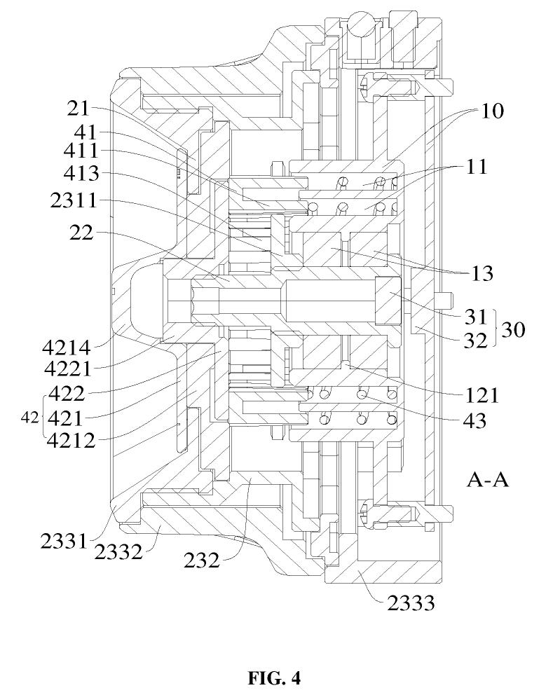

In some aspects, referring to FIGS. 4-7, the actuator 42 includes a knob panel 421 and a pressing panel 422. One of the pressing panel 422 and the knob panel 421 is equipped with an engagement protrusion 4221, while the other is equipped with an engagement slot 4211 (e.g., hole). The pressing panel 422 and the knob panel 421 rotate synchronously via the engagement protrusion 4221 and the engagement slot 4211. The pressing panel 422 is threadedly connected to the rotating assembly 20. The knob panel 421 is rotatably mounted on the rotating assembly 20. Rotation of the knob panel 421 can drive the pressing panel 422 to rotate and move relative to the rotating assembly 20 and the knob panel 421 along the rotation axis. That is, when the knob panel 421 rotates, the pressing panel 422 both rotates and moves, ensuring that the relative distance between the knob panel 421 and the base 10 remains unchanged during the process of adjusting the damping force, which facilitates the user's operation of the knob panel 421. Along the rotation axis, the damping member 41 is positioned between the base 10 and the pressing panel 422, and the pressing panel 422 drives the damping member 41 to move along the rotation axis.

Regarding the aforementioned statement that "the pressing panel 422 and the knob panel 421 rotate synchronously via the engagement protrusion 4221 and the engagement slot 4211", the engagement protrusion 4221 and the engagement slot 4211 can be shape-matched, and the engagement slot 4211 can be a non-circular slot, thereby achieving the effect that the knob panel 421 drives the pressing panel 422 to rotate.

In some aspects, referring to FIGS. 4-7, the rotating assembly 20 has a first through hole 24 penetrating therethrough along the rotation axis. The damping adjustment assembly 40 is located within the first through hole 24. An annular step 21 is formed on the inner wall of the end of the first through hole 24 away from the base 10. The knob panel 421 is can be equipped with a limiting plate 4212 connected to it. Along the rotation axis, the limiting plate 4212 and the knob panel 421 clamp the annular step 21 therebetween to axially position the knob panel 421, such that the knob panel 421 can only rotate relative to the rotating assembly 20. The limiting plate 4212 is located between the knob panel 421 and the pressing panel 422. The limiting plate 4212 is equipped with an engagement slot 4211 for the engagement protrusion 4221 to pass through. That is, the knob panel 421 is positioned farthest from the base 10, and one end of the knob panel 421 is exposed outside the first through hole 24.

The limiting plate 4212 and the knob panel 421 rotate synchronously. There are various schemes for achieving synchronous rotation between the limiting plate 4212 and the knob panel 421, which are not specifically restricted in this disclosure. For example, in some embodiments, the engagement slot 4211 can be provided only on the limiting plate 4212, and the limiting plate 4212 and the knob panel 421 are connected and positioned by other structural components. In other embodiments, engagement slots 4211 can be provided at corresponding positions on both the limiting plate 4212 and the knob panel 421, and the engagement protrusion engages with both the limiting plate 4212 and the knob panel 421.

In some aspects, referring to FIGS. 4-7, the end surface of the knob panel 421 away from the base 10 is exposed outside the rotating assembly 20, and this end surface is equipped with a protruding knob portion 4214. The user can rotate the knob panel 421 by gripping and rotating the knob portion 4214, thereby adjusting the damping force.

In some aspects, referring to FIGS. 4-7, the limiting plate 4212, the knob panel 421, and the pressing panel 422 rotate synchronously. For instance, this can be achieved by fixedly connecting the limiting plate 4212 to the knob panel 421, so that the knob panel 421 drives the limiting plate 4212 and the pressing panel 422 to rotate. Alternatively, for example, if the engagement protrusion 4221 is provided on the pressing panel 422, the limiting plate 4212 can be fixedly connected to the knob panel 421, while the limiting plate 4212 is equipped with an anti-rotation through hole matching the engagement protrusion 4221. The limiting plate 4212 thus receives torque from both the knob panel 421 and the pressing panel 422 and rotates, enhancing the adjustability of the actuator 42.

To enhance the user experience during damping adjustment, in some embodiments, referring to FIGS. 4-7, on the mutually facing end surfaces of the limiting plate 4212 and the annular step 21, one of them is embedded with multiple spring plungers 44, and the other is provided with multiple positioning recesses 211 for accommodating the spring plungers 44. Two of the spring plungers 44 are disposed at opposite ends of the same diameter of an imaginary cylindrical surface defined by the rotation axis about which the actuator 42 rotates relative to the rotating assembly 20. The plurality of positioning recesses 211 are arranged at intervals around the circumference of the imaginary cylindrical surface. That is, as the knob panel 421 rotates, after the limiting plate 4212 and the annular step 21 rotate relative to each other by a certain angle, a spring plunger 44 correspondingly moves from its current positioning recess 211 into an adjacent positioning recess 211. The spring plunger 44 can be a structural component known in the art, including a spring, a steel ball, and a housing. The specific structure of the spring plunger 44 can be referred to in the known art, and no detailed explanation is given here.

When the housing of the spring plunger 44 has external threads for installation and fixation, the spring plunger 44 can be a ball screw. During damping adjustment, the spring plungers 44 can effectively reduce the frictional resistance between the limiting plate 4212 and the annular step 21, while also producing certain audible cues (e.g., indicative sounds) that enhance the user experience.

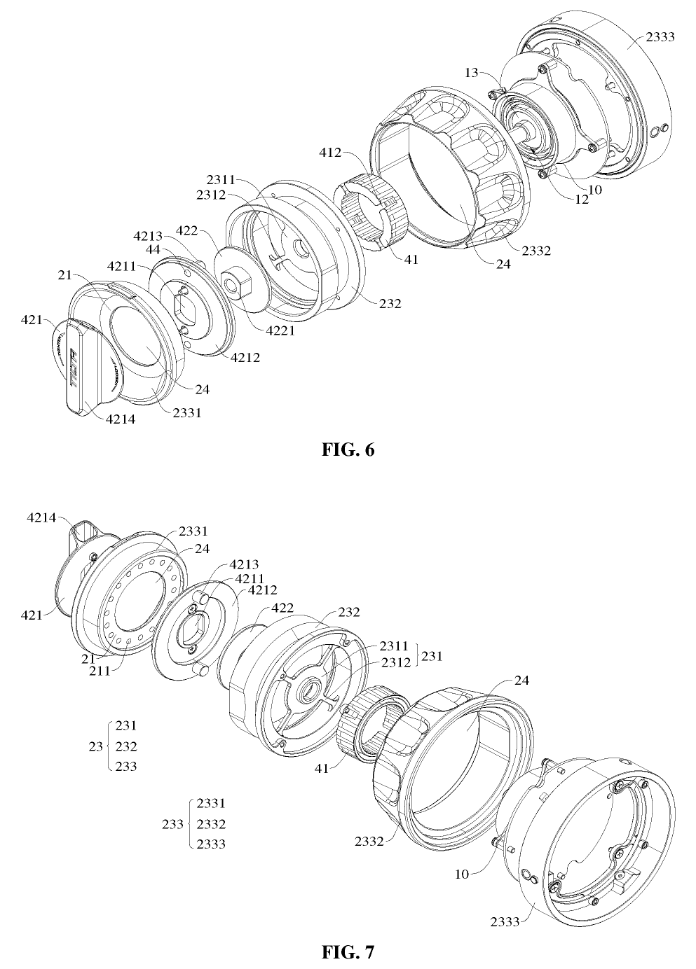

In some aspects, referring to FIGS. 6-9, the base 10 has a connection hole 12, and a bearing 13 is installed within the connection hole 12. The rotating assembly 20 includes a connecting shaft 22 and a rotating housing 23 which are connected. The connecting shaft 22 is mounted in the bearing 13. The rotating housing 23 is rotatably mounted on the base 10 via the connecting shaft 22, such that the connecting shaft 22 and the rotating housing 23 can only rotate relative to the base 10 but are restricted to move in other directions. The actuator 42 is threadedly connected to the connecting shaft 22. The bearing 13, the connecting shaft 22, and the damping member 41 are all located within the rotating housing 23. The end of the actuator 42 facing away from the base 10 is exposed outside the rotating housing 23. To connect the connecting shaft 22 and the rotating housing 23 as one integral unit and achieve their synchronous rotation, a connecting part 231 is formed on the inner wall of the rotating housing 23. The connecting part 231 includes a connecting disk 2311 and multiple ribs 2312 extending towards the connecting shaft 22. One end of each rib 2312 is connected to the inner wall of the rotating housing 23, and the other end is connected to the connecting disk 2311. The connecting disk 2311 is fixedly connected to the connecting shaft 22 via threads. The damping member 41 is equipped with multiple insertion slots 412 corresponding to the ribs 2312. The rotating housing 23 and the damping member 41 are in sliding fit and rotate synchronously via the engaged insertion slots 412 and ribs 2312, thereby allowing the actuator 42 to move relative to the connecting shaft 22 and the rotating housing 23 during damping adjustment.

In some aspects, to enhance the stability and security of the connection between the connecting shaft 22 and the rotating housing 23, while the connecting disk 2311 is threadedly attached to the connecting shaft 22, adhesive can be applied for additional connection and fixation, ensuring synchronous rotation of the connecting shaft 22 and the rotating housing 23. This arrangement guarantees that the connecting shaft 22 and the rotating housing 23 do not rotate relative to each other during the rotation of the actuator 42 to adjust the insertion depth of the insertion segment 411 into the damping groove 11.

The rotation axis about which the rotating assembly 20 rotates relative to the base 10 is the central axis of the connecting shaft 22. The term "multiple ribs 2312" denotes two or more ribs 2312. In alternative embodiments, the connecting disk 2311 can be connected to the connecting shaft 22 via an interference fit or a pin connection. Furthermore, this disclosure does not restrict the specific method for ensuring that the connecting shaft 22 only rotates relative to the base 10 without movement, as long as the connecting shaft 22 rotates in conjunction with the rotating housing 23.

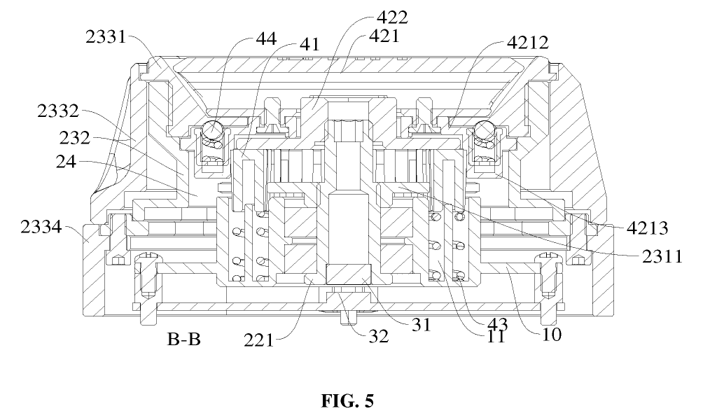

In some aspects, referring to FIGS. 4 and 5, there are two bearings 13. The connection hole 12 of the base 10 features a positioning protrusion 121 for locating the bearings 13. The positioning protrusion 121 is situated between the two bearings 13. The end of the connecting shaft 22 near the base 10 is equipped with a limiting step 221. The connecting disk 2311 is threadedly connected to the connecting shaft 22, thereby positioning the two bearings 13 between the limiting step 221 and the connecting disk 2311.

In some aspects, referring to FIGS. 2-9, to facilitate assembly, production, and manufacturing, the rotating housing 23 includes a detachably connected inner housing 232 and an outer housing 233. The inner housing 232 is installed within the outer housing 233. The connecting part 231 is formed on the inner housing 232. The actuator 42 is rotatably mounted on the outer housing 233. During use, the user can maintain the rotating assembly 20 relatively stationary with respect to the base 10 by holding the outer housing 233 steady. When parameter adjustment is required, rotating the outer housing 233 causes the rotating assembly 20 to drive the damping member 41 and the actuator 42 to rotate together relative to the base 10. The inner housing 232 and the outer housing 233 can be connected via threads, screws, bolts, etc., or assembled into one unit using at least two of these methods. This disclosure does not impose any limitations.

In some aspects, referring to FIGS. 6 and 7, to further simplify assembly and facilitate mold-making for the outer housing 233, the outer housing 233 includes a first shell 2331, a second shell 2332, and a third shell 2333. Along the rotation axis, the first shell 2331, the second shell 2332, and the third shell 2333 are arranged sequentially, with the first shell 2331 being farther from the base 10 than the third shell 2333. The actuator 42 is rotatably mounted on the first shell 2331. Along the rotation axis, one end of the inner housing 232 is detachably connected to the first shell 2331, and the other end of the inner housing 232 is detachably connected to the third shell 2333. The second shell 2332 is snap-fitted between the first shell 2331 and the third shell 2333. The first shell 2331, the second shell 2332, the third shell 2333, and the inner housing 232 can rotate synchronously. In the direction of rotation of the rotating assembly 20 about the connecting shaft 22, the rotating housing 23, the actuator 42, and the damping member 41 rotate substantially synchronously.

For instance, in some embodiments, the first shell 2331 has external threads, and the inner housing 232 has internal threads. The first shell 2331 and the inner housing 232 are connected via threads. The third shell 2333 and the inner housing 232 are fixedly connected via screws. The outer surfaces of the first shell 2331 and the third shell 2333 form flange edges to clamp the second shell 2332 between them. The second shell 2332 encloses the inner housing 232 within the first shell 2331 and the third shell 2333. Synchronous rotation between the second shell 2332 and the first shell 2331/third shell 2333, as well as between the second shell 2332 and the inner housing 232, can be achieved through anti-relative-rotation fitting structures.

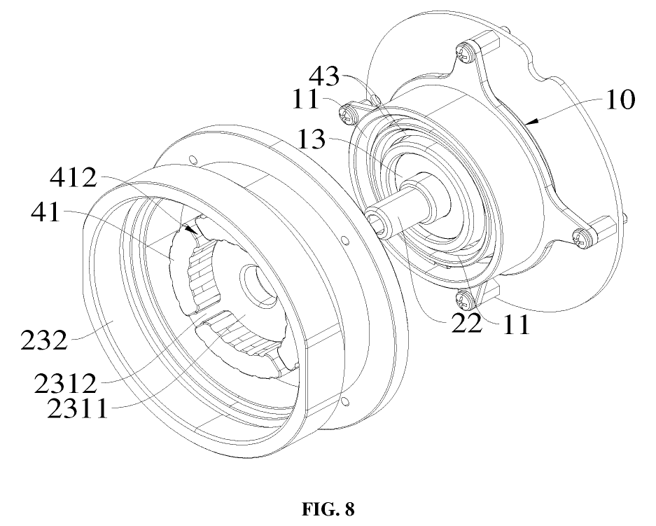

In some aspects, referring to FIGS. 6 and 8, to enhance the adjustability of the damping, the outer profile surface of the insertion segment 411 is formed with a grease groove 413. A portion of the damping grease can adhere within the grease groove 413 and rotate along with it, which helps retain the damping grease on the outer profile surface of the insertion segment 411, thereby ensuring the damping feel during the rotation of the rotating assembly 20 driving the damping member 41 relative to the damping groove 11. Alternatively, the side wall of the damping groove 11 can be formed with a grease groove 413. When the grease groove 413 is present on the side wall of the damping groove 11, after the insertion segment 411 extends into the damping groove 11, the damping grease can flow into the grease groove 413, preventing overflow of the damping grease from the damping groove 11. Additionally, the grease groove 413 effectively increases the contact area between the damping grease and the base 10, further enhancing the sticky sensation (e.g., viscous sensation) during rotation of the rotating assembly 20 relative to the base 10.

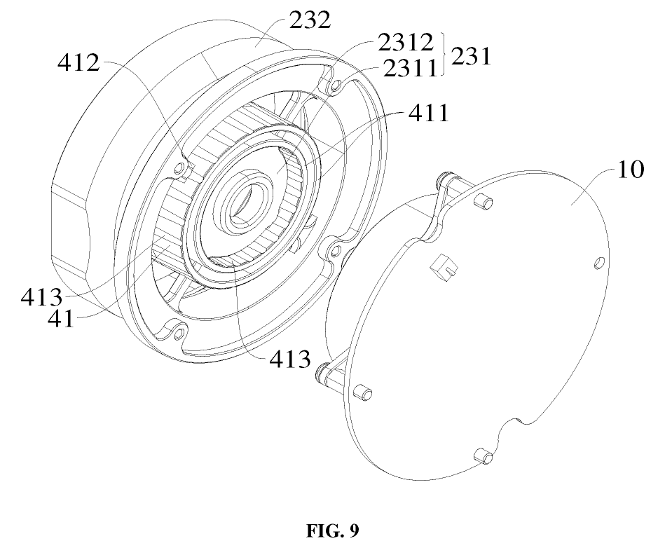

In some aspects, referring to FIGS. 8 and 9, to further enhance the adjustability of the damping, two damping grooves 11 are provided. The two damping grooves 11 are concentrically arranged and can both accommodate damping grease. The insertion segment 411 includes a first insertion segment 411 and a second insertion segment 411, which extend into different damping grooves 11.

In embodiments where the damping adjustment assembly 40 includes an elastic member 43, the elastic member 43 can be provided in only one of the damping grooves 11. Alternatively, elastic members 43 can be provided in both damping grooves 11 to ensure uniform force on the damping member 41 and stable movement of the damping member 41 along the rotation axis.

In some aspects, the damping groove 11 is provided on the base 10. The insertion segment 411 can refer to a part of the structure of the damping member 41 or the entire damping member 41, depending on the inherent structure of the damping member 41.

In some aspects, referring to FIGS. 8 and 9, two damping grooves 11 are provided. The two damping grooves 11 are concentrically disposed on the base 10. The damping member 41 can be an annular plate member with a certain thickness. The inner and outer peripheral surfaces of the damping member 41 are respectively provided with the aforementioned grease grooves 413. The damping member 41 has an annular groove with its opening facing the damping groove 11, thereby forming two concentrically disposed insertion segments 411. The opening of the insertion slot 412 faces away from the damping groove 11, ensuring that the portion of the insertion segment 411 extending into the damping member 41 can be a complete annular structure, which enhances the damping sticky sensation.

In some aspects, in the scheme where the actuator 42 includes the knob panel 421, the pressing panel 422, and the limiting plate 4212, and to assist in positioning the damping member 41 and effectively prevent positional misalignment between the insertion segment 411 and the damping groove 11, referring to FIGS. 5 and 7, the diameter of the limiting plate 4212 is greater than the diameter of the pressing panel 422. The side of the limiting plate 4212 facing the base 10 is provided with a limiting boss 4213. The limiting boss 4213 extends to the outer periphery of the annular damping member 41. Along the radial direction of the limiting plate 4212, the limiting boss 4213 is located outside the pressing panel 422. Both the limiting boss 4213 and the damping member 41 are situated between the inner peripheral wall of the inner housing 232 and the connecting disk 2311. The limiting plate 4212, via the limiting boss 4213, confines the damping member 41 between the inner peripheral wall of the inner housing 232 and the connecting disk 2311.

In some aspects, to make full use of the inherent structure of the limiting plate 4212, the spring plunger 44 can be installed at the location of the limiting boss 4213, thereby effectively reducing the overall size and space occupied by the actuator 42.

In some aspects, referring to the figures, the knob assembly 200 can further include an angle sensing assembly 30. The angle sensing assembly 30 includes a rotating member 31 and a detector 32. The rotating member 31 is fixed to the rotating assembly 20 and rotates synchronously with it. The detector 32 is fixed to the base 10 and is configured to detect the rotation angle of the rotating member 31, thereby detecting the relative rotation angle between the base 10 and the rotating assembly 20, which allows for corresponding control of parameter changes. Since the rotating member 31 of the angle sensing assembly 30 maintains synchronous rotation with the rotating assembly 20, the rotating member 31 and the detector 32 of the angle sensing assembly 30 can monitor the relative rotation between the base 10 and the rotating assembly 20 in real-time and accurately, thereby improving the measurement precision and parameter adjustment precision of the knob assembly 200.

In some aspects, the rotating member 31 includes a magnet, and the detector 32 includes a magnetic encoder. The magnetic encoder is used to detect changes in the magnetic field of the magnet. The detector 32 transmits the detection results to the processing chip of the follow focus remote controller 1000, and the processing chip controls the actuator end of the follow focus remote controller to move accordingly. Referring to FIG. 5, the magnet can be embedded in the end of the connecting shaft 22 near the base 10, and the magnetic encoder is fixed to the area of the base 10 corresponding to the connecting shaft 22.

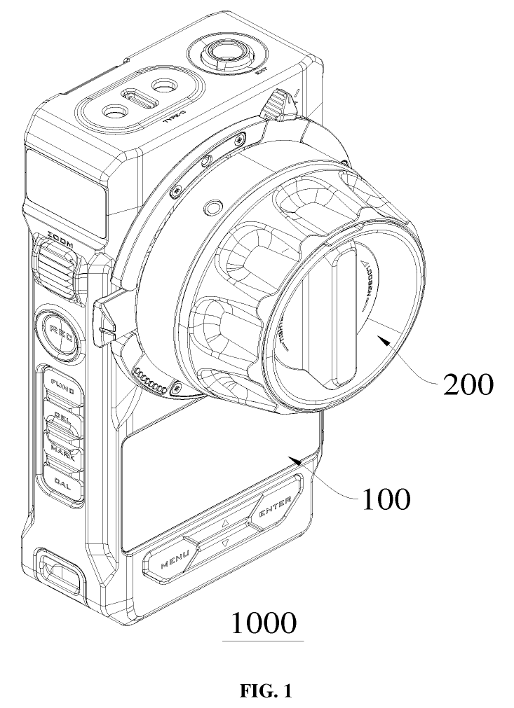

In some aspects, the present disclosure also provides a follow focus remote controller 1000. Referring to FIG. 1, it includes a remote controller main body 100 and the knob assembly 200 according to the aforementioned embodiments. The base 10 of the knob assembly 200 can be fixed to the remote controller main body 100. The follow focus remote controller 1000 incorporating the aforementioned knob assembly 200 naturally possesses all the beneficial effects described above, which will not be repeated here. Other structures of the follow focus remote controller 1000 not described can be referred to in the relevant art, and no detailed explanation is provided here.

In summary, the operation of the knob assembly 200 and the follow focus remote controller 1000 described in this disclosure includes two primary steps. Initially, the rotating assembly 20 is secured to prevent rotation relative to the base 10. Subsequently, the actuator 42 is rotated to move both the actuator 42 and the damping member 41 towards or away from the base 10. This action adjusts the insertion depth of the insertion segment 411 into the damping groove 11, thereby increasing or decreasing the damping force accordingly. Next, the rotating assembly 20 is driven to rotate relative to the base 10. This rotation causes the damping member 41, the actuator 42, and the rotating member 31 to rotate as well. The detector 32 then measures the rotation angle of the rotating assembly 20 and transmits this information to the control system of the remote controller main body 100, enabling parameter adjustment control.

Through enhancements in the connection and transmission relationships among its various components, the knob assembly 200 and the follow focus remote controller 1000 enable the rotating assembly 20 to rotate as a single unit relative to the base 10. When preestablishing the damping force via the damping adjustment assembly 40, the rotating assembly 20 remains stationary. The rotating member 31 of the angle sensing assembly 30 rotates synchronously with the rotating assembly 20, allowing the rotating member 31 and the detector 32 of the angle sensing assembly 30 to monitor the relative rotation between the base 10 and the rotating assembly 20 in real-time and with high accuracy. This effectively enhances the measurement precision and parameter adjustment precision of the knob assembly 200. Additionally, the damping groove 11 is filled with damping grease. Variations in the insertion depth of the insertion segment 411 into the damping groove 11 result in changes to the amount of damping grease filling the gap between them, thereby altering the frictional force generated when the damping member 41 and the base 10 rotate relative to each other. Given that the damping member 41 and the rotating assembly 20 rotate in unison, when the user rotates the rotating assembly 20 relative to the base 10, a pronounced sticky damping sensation is fed back to the user, offering an exceptional tactile experience. Users can adjust the damping feel to their preference, thereby enhancing the adaptability and practicality of the knob assembly 200 and the follow focus remote controller 1000.

The aforementioned description employs specific examples to elucidate the disclosure, serving solely as an aid to comprehension and not intended to impose limitations. For individuals skilled in the relevant art, based on the principles of this disclosure, various straightforward deductions, modifications, or substitutions can also be made.

Although specific embodiments of the invention have been described in detail, it should be understood that the invention is not limited to the exemplary configurations and components shown and described. Parts may be substituted, elements may be reversed, and certain features may be used independently of others, all without departing from the scope of the invention as defined by the claims. Various alternatives, modifications, and equivalents will be apparent to those skilled in the art. For example, the shape, dimensions, or materials of components may be varied, and mechanical linkages may be replaced with equivalent mechanisms that perform the same function. Such alternatives are considered to be within the scope of the invention as defined by the following claims.

The drawings and the associated descriptions are provided to illustrate embodiments of the invention and are not intended to limit the scope of the invention. Relative terms such as “upper,” “lower,” “left,” “right,” “front,” and “rear” are used for convenience only and are not intended to limit the invention to any particular orientation.

What is claimed is:

1. A knob assembly comprising:
a base;
a rotating assembly rotatably mounted on the base; and
a damping adjustment assembly comprising a damping member and an actuator;
wherein the damping member is disposed between the base and the actuator;
wherein the actuator is movably connected to the rotating assembly;
wherein the actuator is configured to rotate relative to the rotating assembly about a rotation axis of the base and the rotating assembly, and convert rotation into linear movement along the rotation axis to drive the damping member to move along the rotation axis;
wherein a damping groove for accommodating damping grease is provided at one of the base and the damping member, and an insertion segment for extending into the damping groove along the rotation axis is provided at the other one of the base and the damping member; and
wherein the actuator is configured to drive the damping member to move, so as to change an insertion depth of the insertion segment into the damping groove.

2. The knob assembly according to claim 1, wherein the damping adjustment assembly further comprises an elastic member;
wherein the elastic member is installed in the damping groove and abuts against the insertion segment; and
wherein the elastic member presses the damping member against the actuator, so as to adaptively adjust a position of the damping member according to a position of the actuator, thereby changing the insertion depth of the insertion segment into the damping groove.

3. The knob assembly according to claim 1, wherein the actuator comprises a knob panel and a pressing panel;
wherein an engagement protrusion is provided at one of the pressing panel and the knob panel, and an engagement slot is provided at the other one of the pressing panel and the knob panel;
wherein the pressing panel and the knob panel are configured to rotate synchronously via the engagement protrusion and the engagement slot;
wherein the pressing panel is threadedly connected to the rotating assembly;
wherein the knob panel is rotatably mounted on the rotating assembly;
wherein a rotation of the knob panel drives the pressing panel to rotate and to move relative to the rotating assembly and the knob panel along the rotation axis;
wherein the damping member is disposed between the base and the pressing panel along the rotation axis; and
wherein the pressing panel is configured to drive the damping member to move along the rotation axis.

4. The knob assembly according to claim 3, wherein the rotating assembly is provided with a first through hole penetrating along the rotation axis;
wherein the damping adjustment assembly is located within the first through hole;
wherein an inner wall of an end of the first through hole away from the base is formed with an annular step;
wherein the knob panel is further provided with a limiting plate;
wherein the limiting plate is connected to the knob panel;
wherein, along the rotation axis, the limiting plate and the knob panel clamp the annular step to axially position the knob panel;
wherein the limiting plate is located between the knob panel and the pressing panel; and
wherein the limiting plate is provided with an engagement slot for the engagement protrusion to pass through.

5. The knob assembly according to claim 4, wherein the limiting plate, the knob panel, and the pressing panel are configured to rotate synchronously;
wherein, on mutually facing end surfaces of the limiting plate and the annular step, one of the limiting plate and the annular step is embedded with a plurality of spring plungers, and the other one of the limiting plate and the annular step is provided with a plurality of positioning recesses for accommodating the spring plungers;
wherein two of the spring plungers are disposed at two ends of a same diameter of an imaginary cylindrical surface where a rotation shaft of the actuator relative to the rotating assembly is located; and
wherein the positioning recesses are arranged at intervals circumferentially around the imaginary cylindrical surface.

6. The knob assembly according to claim 1, wherein the base comprises a connection hole, and a bearing is installed in the connection hole;
wherein the rotating assembly comprises a connecting shaft and a rotating housing;
wherein the connecting shaft is mounted in the bearing;
wherein the rotating housing is rotatably mounted on the base via the connecting shaft;
wherein the actuator is threadedly connected to the connecting shaft;
wherein the bearing, the connecting shaft, and the damping member are all located within the rotating housing;
wherein an end of the actuator facing away from the base is exposed outside the rotating housing;
wherein an inner wall of the rotating housing is formed with a connecting part;
wherein the connecting part comprises a connecting disk and a plurality of ribs extending toward the connecting shaft;
wherein one end of each of the ribs is connected to the inner wall of the rotating housing, the other end of each of the ribs is connected to the connecting disk;
wherein the connecting disk is threadedly connected to the connecting shaft;
wherein the damping member is provided with a plurality of insertion slots corresponding to the ribs; and
wherein the rotating housing and the damping member are in sliding fit and rotate synchronously through engagement of the insertion slots and the ribs.

7. The knob assembly according to claim 6, wherein the rotating housing comprises an inner housing and an outer housing detachably connected to the inner housing;
wherein the inner housing is installed within the outer housing;
wherein the connecting part is formed on the inner housing; and
wherein the actuator is rotatably mounted on the outer housing.

8. The knob assembly according to claim 1, wherein an outer profile surface of the insertion segment is formed with a grease groove.

9. The knob assembly according to claim 1, wherein a side wall of the damping groove is formed with a grease groove.

10. The knob assembly according to claim 1, wherein an outer profile surface of the insertion segment and a side wall of the damping groove are formed with a grease groove.

11. The knob assembly according to claim 1, wherein two damping grooves are provided, and the two damping grooves are concentrically arranged;
wherein the insertion segment comprises a first insertion segment and a second insertion segment; and
wherein the first insertion segment and the second insertion segment are configured to extend into different ones of the two damping grooves.

12. A follow focus remote controller comprising:
a remote controller main body and the knob assembly according to claim 1, wherein the base of the knob assembly is fixable to the remote controller main body.
